(19) United States
(12) Patent Application Publication
(10) Pub. No.: US 2011/0290342 A1
(43) Pub. Date: Dec. 1, 2011

(54) FUEL CAP DUST COVER

(76) Inventors: Jeff Tilbury, Fort Frances (CA); George Tilbury, Metila (CA)

(21) Appl. No.: 12/735,803

(22) PCT Filed: May 6, 2010
(86) PCT No.: PCT/CA2010/000696

§ 371 Date: Jul. 5, 2011

(30) Foreign Application Priority Data
Feb. 23, 2010 (CA) 2694106

(51) Int. Cl. B60K 15/05

(52) U.S. Cl. 137/381

(57) ABSTRACT

Devise for covering over the fuel cap and fuelling area (fuel tank filler neck) for agriculture, construction, industrial, commercial, and forestry equipment that is fuelled by diesel or gas fuel. The devise is made out of material that is fire, water and oil (chemical) resistant or retardant. It is long enough to cover several inches down the fuel tank filler neck area of each piece of equipment in order to keep that area clean from any dirt or debris that might get into the fuel tank upon fuelling that had accumulated on the cap or that area between fuelling It has a Velcro enclosure system and elastic cuff that would allow it to fit snuggling along the bottom so that it would not fall off when the piece of equipment is in operation.

This invention relates to a devise that is placed over the fuel cap and fuel tank filler neck area of any fuel operated machinery (agriculture, commercial, industrial) to ensure these areas remain free of dirt and debris, once the cover is removed.

It is common for fuel (gas and especially diesel) driven machines (tractors, combines, bulldozers, skidders etc) to have dirt and debris accumulation on the fuel cap and around fuel tank filler neck areas when operating in dirty and dusty conditions. This often results in dirt or debris getting into the fuel tank when the cap is removed which can result in extensive damage to the fuel system and engine of the machine, often requiring costly repair and several days where the machine is not in operation.

This devise would allow the fuel cap and fuel tank filler neck area to remain free of dirt and debris as it would cover over the cap and this area and upon removal of the devise any dirt or debris that had built up on it can be removed easily by shaking or brushing the devise by hand away from the fuel cap and fuel tank filler neck area before it is then refitted over the fuel cap and fuelling area.

The embodiments of the invention in which an exclusive property or privilege is claimed are defined as follows:

1. A manually operable tubular sleeve like devise for covering the fuel cap and the fuel tank filler neck area of any gas and diesel driven agriculture, commercial, forestry and industrial heavy equipment.

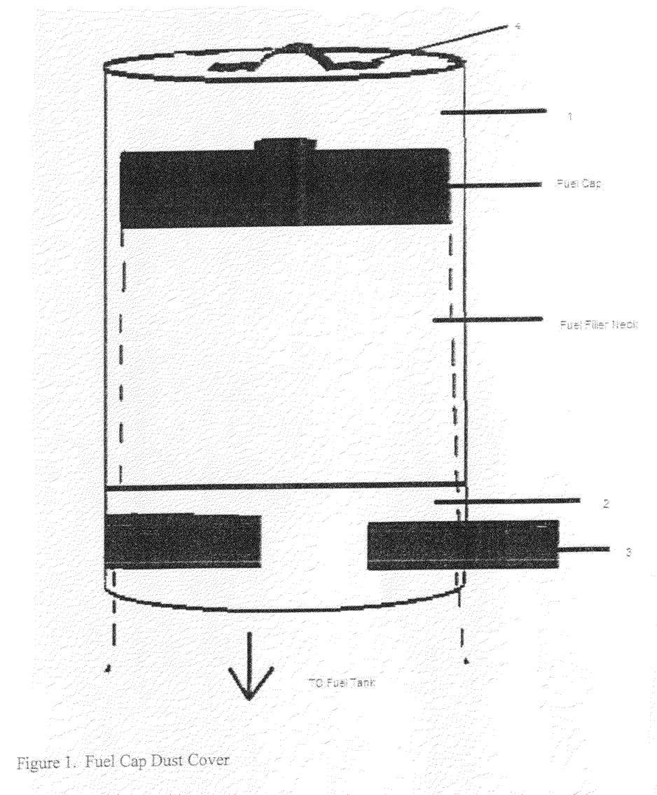

2. Consists of a 4.5 to 6 inch tubular sleeve like devise made of fire, oil and water resistant/retardant material. Item 1 in FIG. 1.

3. It has a 1.5 to 2 inch elasticized cuff fitted (Item 2 in FIG. 1) with a Velcro closing system (Item 3 in FIG. 1) that allows the devise to fit snugly onto the Fuel filler neck so it will not slide off while the machine is in operation. As well it can be easily removed for fuelling and then replaced on the fuel filler neck area between fuelling.

4. It has a 1 inch wide strap handle (Item 4 in FIG. 1) on the top of the device, where two fingers can fit under and the device can be easily removed and replaced over the fuel cap and onto the fuel filler neck area

5. This devise can be utilized on any fuel filler neck system for several different models and types of gas or diesel fuelled machines within the agricultural, forestry, commercial, industrial sectors with the sole purpose to keep the fuel filler neck and fuel cap area clean of dirt and debris, further preventing it getting into the fuel system when fuelling.
